(19) United States
(12) Patent Application Publication
(10) Pub. No.: US 2011/0286224 A1
(43) Pub. Date: Nov. 24, 2011

(54) LIGHT SOURCE FIXING STRUCTURE OF LAMP

(75) Inventor: Yukio Nomura, Shizuoka (JP)

(73) Assignee: KOITO MANUFACTURING CO., LTD., Tokyo (JP)

(21) Appl. No.: 13/111,097

(22) Filed: May 19, 2011

(30) Foreign Application Priority Data
May 20, 2010 (JP) 2010-115895

(51) Int. Cl. F21V 21/08

(52) U.S. Cl. 362/396

(57) ABSTRACT

A light source fixing structure of a lamp is provided. The structure includes a lamp body having a mounting base, a light source having a disc flange, and a set spring elastically contacting the disc flange to fix the disc flange to the mounting base. The lamp body includes a latch protrusion to lock the set spring. The set spring includes a support portion supported on the lamp body, a manually operable lock operating portion, and an elastically contacting portion. An operation of the lock operating portion in one direction causes the elastically contacting portion to elastically contact the back surface of the disc flange and generates an elastic reaction force in a direction different from the one direction. The elastic reaction force urges the lock operating portion toward the latch protrusion and causes the lock operating portion to engage with the latch protrusion.

### CROSS-REFERENCE TO RELATED APPLICATION(S)

The present application claims the benefit of priority of Japanese Patent Application No. 2010-115895, filed on May 20, 2010, the disclosure of which is incorporated herein by reference.

### TECHNICAL FIELD

The present disclosure relates to a structure for fixing a light source to a body of a lamp.

### BACKGROUND

Various lamps such as vehicle lamps have a lamp body and a light source fixed to the lamp body. The lamp body may be a reflector. The light source may be a light bulb or a semiconductor light emitting device. The light source is fixed to the lamp body in a detachable manner to allow replacement of the light source or changing of the light source to a different type of light source. A related art fixing structure of this kind uses a wire spring called a set spring.

According to a first related art example, a fixing structure has a reflector, a bulb socket, and a set spring arranged to fix the bulb socket to the reflector. To fix the bulb socket to the reflector, a base portion of the set spring is supported by the reflector on one side of the bulb socket, the set spring is turned over around the supported portion of the base portion such that a distal end portion moved to the other side of the bulb socket, and the distal end portion is locked on the reflector, whereby the set spring elastically contacts the bulb socket (see, e.g., Japanese Patent Document JP 9-7401 A).

According to a second related art example, a fixing structure has a reflector, a discharge bulb equipped with an igniter, and a set spring arranged to fix the discharge bulb to the reflector. In this structure, the set spring cannot be turned around like in the first related art example because of the presence of the igniter. Accordingly, to fix the discharge bulb to the reflector, a base portion of the set spring is engaged with the reflector, flexible portions extending from respective sides of the base portion are inserted into an annular groove provided between the igniter and a flange on the discharge bulb such that flexible portions elastically contact the flange of the discharge bulb toward the reflector (see, e.g., Japanese Patent Document JP 2002-208302 A).

In these related art examples, the distal end portion or the flexible portions (hereinafter, a free end portion) of the set spring are engaged with a latch portion provided on the reflector to maintain the elastically contacting force of the set spring for fixing the bulb to the reflector. To securely engage the set spring, the latch portion is configured such that a portion of the reflector is protruded and bent in a hook shape to provide a latch groove, in which the free end portion of the set spring is inserted to maintain the elastically deformed condition of the set spring. When locking the set spring on the reflector, the free end portion of the set spring is operated to guide the free end portion to the latch groove in a condition of being flexed against the resilient force of the set spring, and then to move the free end portion along the hook shape of the latch groove.

More specifically, according to the first related art example, the free end portion is moved to the entrance of the latch groove while pressing and deforming the free end portion toward the bulb to press the bulb against the reflector. The free end portion then is deformed in a radially inward direction of the bulb and is inserted to the end of the latch groove so that the free end portion is locked. According to the second related art example, the free end portion is moved to the entrance of the latch groove while pressing and deforming the free end portion toward the bulb to press the bulb against the reflector. Then, a pressing force acting in an inward direction on the free end portion is reduced so that the free end portion is inserted to the end of the latch groove by elastic restoration of the set spring, whereby the free end portion is locked.

On the other hand, when releasing the free end portion of the set spring to remove the bulb from the reflector, the free end portion is operated in an opposite manner to the operation described above for locking the free end portion. That is, in the first related art example, the free end portion is deformed in a radially outward direction of the bulb while pressing the free end portion toward the bulb. In the second related art example, to remove the free end portion from the latch groove, the free end portion of the set spring is moved in a direction away from the bulb while deforming the free end portion in the radially inward direction of the bulb, and then, the deformation of the free end portion in the radial direction of the bulb is released to remove the free end portion from the latch groove using the elastic restoration of the free end portion.

Thus, when locking or releasing the free end portion of the set spring in the first and second related art examples, the free end portion is moved or deformed while deforming the free end portion in a different direction, which makes the operation of the set spring complex. In particular, vehicle lamps are generally designed to have a limited space behind the bulb to keep a size of the lamp small, which makes the locking and releasing operations of the set spring difficult.

### SUMMARY

The present disclosure provides a light source fixing structure capable of locking a set spring by operating the set spring in one direction and releasing the set spring by operating the set spring in another direction, so that operations for attaching and detaching a light source with respect a lamp body are simplified.

According to an aspect of the present disclosure, a light source fixing structure of a lamp is provided. The structure includes a lamp body having a mounting base on a back surface thereof, a light source having a disc flange arranged to abut the mounting base, and a set spring supported on the lamp body and elastically contacting the disc flange to fix the disc flange to the mounting base. The lamp body includes a latch protrusion configured to lock the set spring. The set spring includes a support portion supported on the lamp body, a lock operating portion manually operable to engage the lock operating portion with, and an elastically contacting portion configured to elastically contact a back surface of the disc flange in a region between the support portion and the lock operating portion. The light source fixing structure is configured such that, an operation of the lock operating portion in one direction causes the elastically contacting portion to elastically contact the back surface of the disc flange and generates an elastic reaction force in a direction different from the one direction, and such that the elastic reaction force urges the lock operating portion toward the latch protrusion and engages the lock operating portion with the latch protrusion.

Other aspects and advantages of the present disclosure will be apparent from the following description, the drawings and the claims.

### BRIEF DESCRIPTION OF THE DRAWINGS

FIG. 1 is a partially exploded view of a fixing structure;

FIG. 2 is an enlarged perspective view of a latch portion of a fixing structure;

FIG. 3A is a rear view of a fixing structure in which a light source is not set in position;

FIG. 3B is a rear view illustrating an operation for fixing a light source;

FIG. 4 is a perspective view of a fixing structure in which a light source is fixed;

FIG. 5A is a partial sectional view of the fixing structure of FIG. 3A observed in the direction A;

FIG. 5B is a partial sectional view of the fixing structure of FIG. 3A observed in the direction B;

FIG. 6A a partial sectional view of the fixing structure of FIG. 3B observed in the direction A;

FIG. 6B a partial sectional view of the fixing structure of FIG. 3B observed in the direction B;

FIG. 7 is a partially exploded view of a fixing structure;

FIG. 8 is a perspective view of a fixing structure in which a holder is attached to a lamp body; and

FIG. 9 is a partial sectional view of a fixing structure in which a light source is fixed.

### DETAILED DESCRIPTION

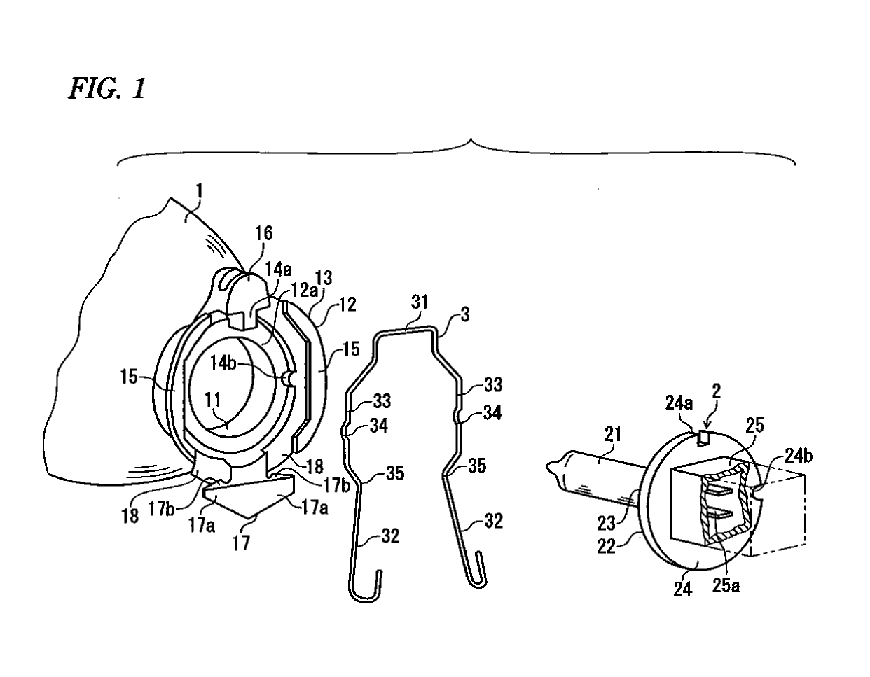

FIG. 1 is a partially exploded perspective view of a light source fixing structure of a vehicle headlamp HL. The headlamp HL includes a paraboloidal reflector 1, whose diameter is increased toward the front and having an opening at the front, and a light source 2 attached to the reflector 1. The light source 2 may include an incandescent bulb or an LED light emitting device. According to this embodiment, the light source 2 includes an incandescent bulb 21. The light source 2 has a bulb socket 22 configured to receive and support the incandescent bulb 21. The bulb socket 22 has a socket portion 23 in which the incandescent bulb 21 is fitted and supported, a disc flange 24 surrounding the socket portion 23, and a connector portion 25 integrally formed on the disc flange 24 to supply electric power to the incandescent bulb 21. The connector portion 25 has terminals 25a to which an electric connector connected to an in-mounted power supply is fitted. Positioning cutouts 24a, 24b are respectively formed at two positions on the circumference of the disc flange 24, i.e., an upper position on an upper portion of the circumference of the disc flange 24 when the bulb socket 22 is attached to the reflector 1, and another position different from the upper position. The positioning cutouts 24a, 24b are formed in different shapes. For example, the upper positioning cutout 24a is rectangular, and the other positioning cutout 24b is circular.

A circular bulb inserting hole 11 is opened in the back surface of the reflector 1. The bulb inserting hole 11 has a sufficient diameter allowing the incandescent bulb 21 to be inserted into the bulb inserting hole 11. A bulb mounting base 12 is formed around the bulb inserting hole 11. The bulb mounting base 12 has an annular mounting surface 12a, which is a portion of the back surface of the reflector 1, surrounding the bulb inserting hole 11. The bulb mounting base 12 further includes a wall portion 13 having a substantially circular inner wall 14 surrounding the mounting surface 12a, and an outer wall 15 formed to have a substantially octagonal inner shape and higher than, i.e., extending more toward the back than, the inner wall 14. The disc flange 24 of the bulb socket 22 is inserted into a circular region surrounded by the inner wall 14. The disc flange 24 is fixed to the bulb mounting base 12 by a set spring 3 such that the front surface of the disc flange 24 abuts the mounting surface 12a of the bulb mounting base 12.

The set spring 3 is formed by bending a wire spring in a substantially inverted U-shape. A central portion of the set spring 3 serves as a support portion 31 supported by the bulb mounting base 12. Each of the distal end portions of the set spring 3 is extended to protrude radially outward from the wall portion 13 of the bulb mounting portion 12 and is bent substantially in an U-shape, serving as a lock operating portion 32. The lock operating portions 32 are configured to engage with the wall portion 13 of the bulb mounting base 12 when a worker pinches the lock operating portions 32 to elastically deform the lock operating portions 32 in a direction in which the lock operating portions 32 move toward each other. A portion between the support portion 31 and each of the lock operating portions 32 serves as an elastically contacting portion 33, which is bent laterally outward into a trapezoidal shape along the octagonal shape of the outer wall 15 of the bulb mounting base 12. The elastically contacting portion 33 has bent portions 34, 35, each being bent so as to be convex toward the front, at two positions on the longitudinal direction of the elastically contacting portion 33 such that, when abutting against the back surface of the disc flange 24 of the bulb socket 22, the bent portions 34, 35 elastically contact the back surface of the disc flange 24 and exert an elastically contacting force which presses the disc flange 24 against the mounting surface 12a of the bulb mounting base 12.

Positioning protrusions 14a, 14b, each protruding toward the center of the bulb mounting base 12, are provided on the inner wall 14 at two positions on the circumferential direction of the inner wall 14. In this embodiment, the rectangular positioning protrusion 14a is provided at an upper part of the inner circumference of the inner wall 14, and the circular positioning protrusion 14b is provided at a position on the inner circumference of the inner wall 14 that is about at a right angle from the positioning protrusion 14a. The positioning protrusions 14a, 14b fit into the positioning cutouts 24a, 24b of the disc flange 24, respectively. When the disc flange 24 is inserted into the inside of the inner wall 14, the bulb socket 22 is positioned with respect to the circumferential direction by the positioning protrusions 14a, 14b and the positioning cutouts 24a, 24b. Further, the positioning protrusions 14a, 14b and the positioning cutouts 24a, 24b prevent the bulb socket 22 and the incandescent bulb 21 from being turned around an axis of the incandescent bulb 21. An engaging portion 16 is provided at the upper portion of the circumference of the wall portion 13 in a radially outwardly protruding manner. The support portion 31 of the set spring 3 is hooked onto the engaging portion 16 from the outside, so that the set spring 3 is supported by the engaging portion 16.

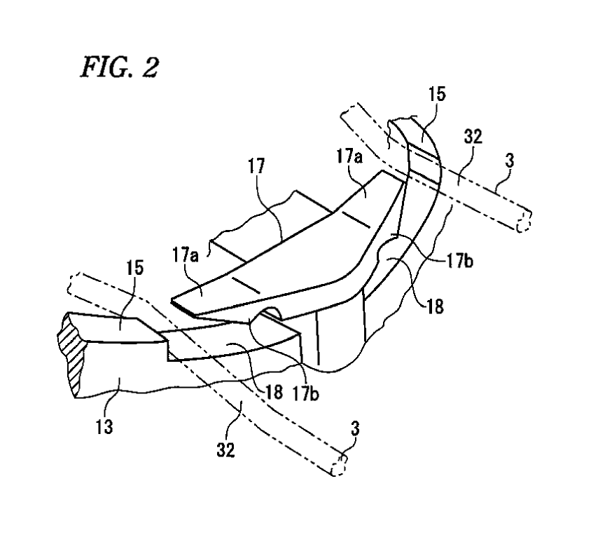

A latch portion 17 protruding from the outer wall 15 in the radially outward direction of the wall portion 13 is formed at the lower portion of the circumference of the wall portion 13. As shown in FIG. 2, the latch portion 17 includes a pair of both sleeves 17a laterally protruding in the tangential direction of the circumference of the outer wall 15. A guide groove 18 is formed between the back surface of the outer wall 15 and each of both of the sleeves 17a such that an associated one of the lock operating portions 32 is inwardly guided and inserted into the guide groove 18. In this embodiment, each of the guide grooves 18 is configured as a slit which is formed by cutting off a portion of the circumference of the back surface of the outer wall 15 and inclined toward the bottom of the wall portion 13 from the outside to the inside between the cut portion and the sleeve 17a of the latch portion 17. An angled latch protrusion 17b protruding downwardly is formed along the circumferential direction of the wall portion 13 on the upper surface of each of the guide grooves 18, i.e., on the bottom surface of each of the sleeves 17a of the latch portion 17. The latch protrusion 17b is formed such that an angle of inclination of the slope is relatively small. More specifically, as will be described below, each of the latch protrusions 17b is configured to have such a shape and dimensions that allows the lock operating portion 32 of the set spring 3 to move along the slope of the latch protrusion 17b, but when the lock operating portion 32 is urged in the direction toward the upper surface of the guide groove 18 at an inner side the guide groove 18, the lock operating portion 32 is prevented from moving along the slope of latch protrusion 17b.

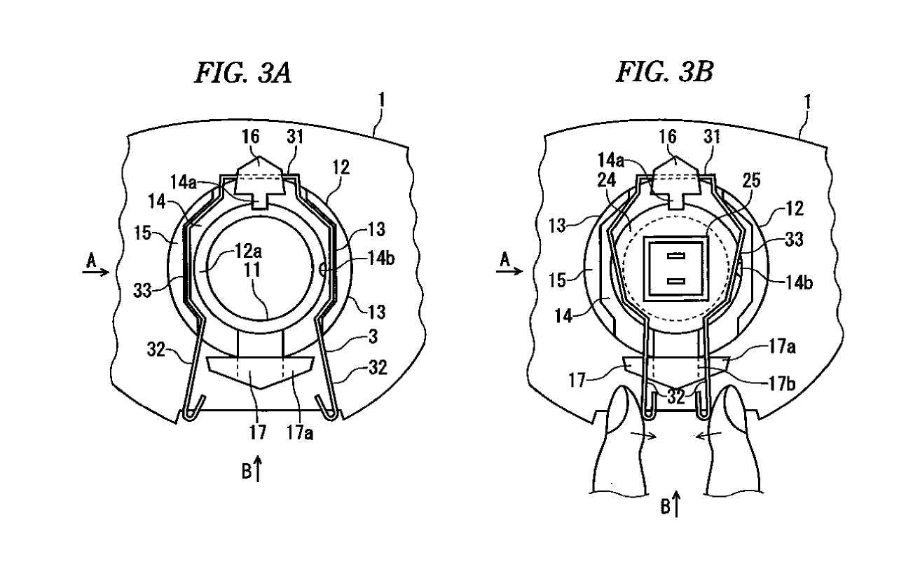

Referring to FIG. 3A, with the above configuration, when fixing the light source 2 to the reflector 1, first, the support portion 31 of the set spring 3 is engaged with the engaging portion 16 of the bulb mounting base 12 of the reflector 1. Each of the elastically contacting portions 33 is arranged to extend along the inner edge of the outer wall 15 due to the shape of the set spring 3, and to face an associated one of the guide grooves 18 of the latch portion 17. Then, the incandescent bulb 21 of the light source 2 is inserted into the bulb inserting hole 11 from behind the back surface of the reflector 1. The disc flange 24 of the bulb socket 22 is inserted into the region surrounded by the inner wall 14, and the front surface of the disc flange 24 is caused to abut the mounting surface 12a of the bulb mounting base 12. The elastically contacting portion 33 of the set spring 3 is positioned on the back surface of the inner wall 14. Thus, the insertion and abutment of the disc flange 24 are not obstructed.

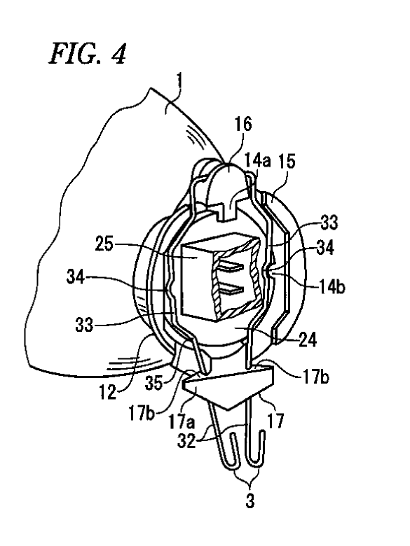

Referring next to FIG. 3B, when a worker pinches the lock operating portions 32 of the set spring 3 with his fingers and deforms the lock operating portions 32 inwardly so as to move them toward each other, each of the lock operating portions 32 is inserted into the associated guide groove 18. Simultaneously, the elastically contacting portion 33 is moved in the radially inward direction to the back surface of the disc flange 24 of the bulb socket 22. The elastically contacting portion 33 is caused to abut against the back surface of the disc flange 24 at the bent portions 34, 35. This abutment causes an elastic deformation of the elastically contacting portion 33. A reaction force due to the deformation causes the disc flange 24 to elastically contact the mounting surface 12a of the bulb mounting base 12. Such elastic deformation of the set spring 3 brings the lock operating portions 32 into a state in which each of the lock operating portions 32 is urged inside the associated guide groove 18 toward the upper surface of the guide groove 18. An urging force due to such elastic deformation brings the lock operating portions 32 into a state in which each of the lock operating portions 32 elastically contacts the upper surface of the associated guide groove 18. When the worker further deforms the lock operating portions 32 inward, each of the lock operating portions 32 is moved to the innermost end of the associated guide groove 18 beyond the associated latch protrusion 17b against the urging force. Thus, even when the worker releases his hand from the lock operating portions 32 and releases the deforming force, the lock operating portions 32 are held in a state in which each of the lock operating portions 32 abuts the upper surface of the associated guide groove 18 at the innermost end of the guide groove 18 and is prevented from being removed from the associated guide groove 18 across the associated latch protrusion 17b. Accordingly, the elastically contacting portions 33 are maintained in a state in which the elastically contacting portions 33 elastically contact the back surface of the disc flange 24 so as to elastically contact the mounting surface 12a of the bulb mounting base 12. Thus, as illustrated in FIG. 4, the light source 2 is fixed to the bulb mounting base 12 of the reflector 1. Consequently, the set spring 3 is engaged with the bulb mounting base 12 only by performing a single operation of inwardly deforming the lock operating portions 32. Accordingly, the light source 2 is fixed to the reflector 1. An operation of fixing the light source 2 can be simplified. Especially, when the light source 2 is not set in position on the bulb mounting base 12, the lock operating portions 32 of the set spring 3 are not locked on the latch protrusions 17b, and the elastically contacting portions 33 are elastically retreated in an outward direction. In this state, the light source 2 can be set on the bulb mounting base 12. Consequently, an operation of fixing the light source 2 is facilitated.

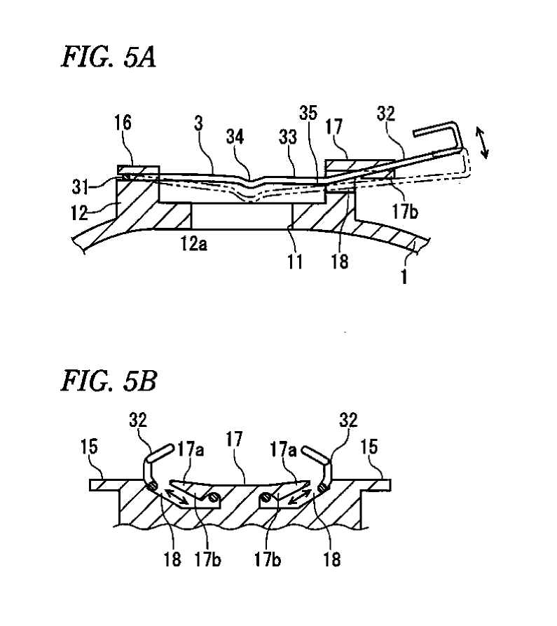

In a state in which the light source 2 is not set in position on the bulb mounting base 12, as illustrated in FIG. 3A, and in which only the set spring 3 is attached to the bulb mounting base 12, the set spring 3 is such that the elastically contacting portions 33 are positioned along the back surface of the inner wall 14, as illustrated in FIGS. 5A and 5B. When the lock operating portions 32 are operated to be inwardly deformed and to be inserted into the guide groove 18, the bent portions 34, 35 of the elastically contacting portion 33 do not abut the back surface of the disc flange 24, because the disc flange 24 of the light source 2 is inserted into the bulb mounting base 12. Thus, no elastically contacting force is generated. Accordingly, the set spring 3 is such that the lock operating portions are not urged towards the upper surface of the guide groove 18. Therefore, the set spring 3 can be freely moved to a position shown in solid lines and to a position shown in two-dotted chain lines in FIG. 5A. Accordingly, each of the lock operating portions 32 can easily be moved inside the associated guide groove 18 across the associated latch protrusion 17b in any of an inward and outward direction and an up and down direction, and is not locked by the latch protrusions.

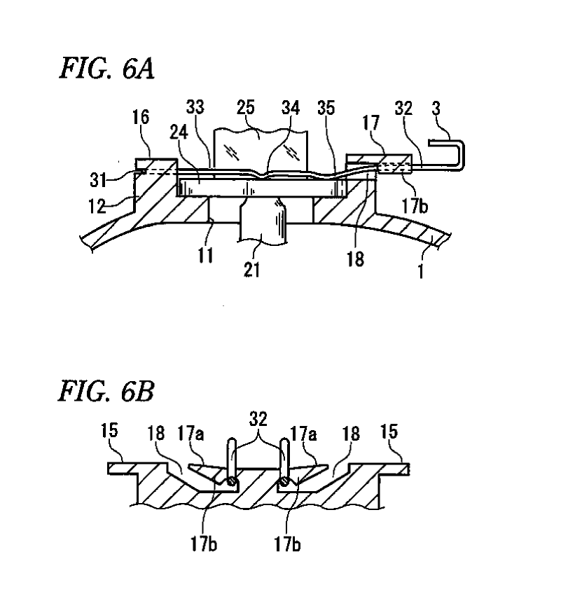

On the other hand, when the light source 2 is set in position on the bulb mounting base 12, as illustrated in FIG. 3B, the disc flange 24 is inserted to contact the bulb mounting base 12. Thus, when the lock operating portions 32 of the set spring 3 are operated, the bent portions 34, 35 of the elastically contacting portion 33 abut against the back surface of the disc flange 24, as illustrated in FIGS. 6A and 6B. Consequently, an elastically contacting force is generated, so that the set spring 3 is brought into a state in which the lock operating portions 32 are urged towards the upper surface of the guide groove 18. Accordingly, the lock operating portions 32 cannot easily move in the guide grooves 18 in the up-down direction. In addition, the lock operating portions 32 cannot move back beyond the latch protrusions 17b. Thus, the lock operating portions 32 are prevented by the latch protrusions 17b from moving in an inward-outward direction. The fixing of the light source 2 can be fixed by the set spring 3.

To cancel the fixing of the bulb socket 22 to remove the light source 2 from the reflector 1, the lock operating portions 32 of the set spring 3 are deformed by pushing down each of the lock operating portions 32 toward the lower surface of the associated guide groove 18. The latching of the lock operating portions by the latch protrusions 17b is canceled by this depressing deformation. In addition, each of the lock operating portions 32 is outwardly moved by the elastic restoring force of the set spring 3. Thus, the lock operating portions 32 are removed from the guide grooves 18. Simultaneously, the elastically contacting portions 33 are elastically restored in an outward direction, and retreated from the back surface of the disc flange 24. Thus, a force for causing the disc flange 24 to elastically contact the bulb mounting base 12 is released. Consequently, the light source 2 can be removed from the reflector 1. This operation can be performed individually on the lock operating portions 32. Alternatively, this operation can be performed simultaneously on the lock operating portions 32. Thus, the elastic contact state of the light source 2 by the set spring 3 can be canceled only by a single operation of performing pressing-deformation of each of the left and right lock operating portions 32 in one direction towards the lower surface of the associated guide groove 18. Consequently, the light source 2 can be removed from the reflector 1. An operation of removing the light source 2 can be simplified.

According to the first embodiment, the bulb mounting base 12 supports the set spring 3 by hooking the support portion 31 of the set spring 3 on the engaging portion 16. In addition, a tongue-like support piece configured as a separate member can be fixed to the bulb mounting base 12 by screws or the like to hold the support 31 of the set spring 3 at a portion of the wall portion 13, so that the set spring 3 can reliably be prevented from dropping off the engaging portion 16 when the set spring 3 is operated.

In the first embodiment, an example using an incandescent bulb serving as the light source 2 has been described. However, an LED light emitting device can be used as the light source. In this case, the disc flange 24 may be provided as a base member that holds the LED light emitting device to fix the light source to the bulb mounting base 12 of the reflector 1.

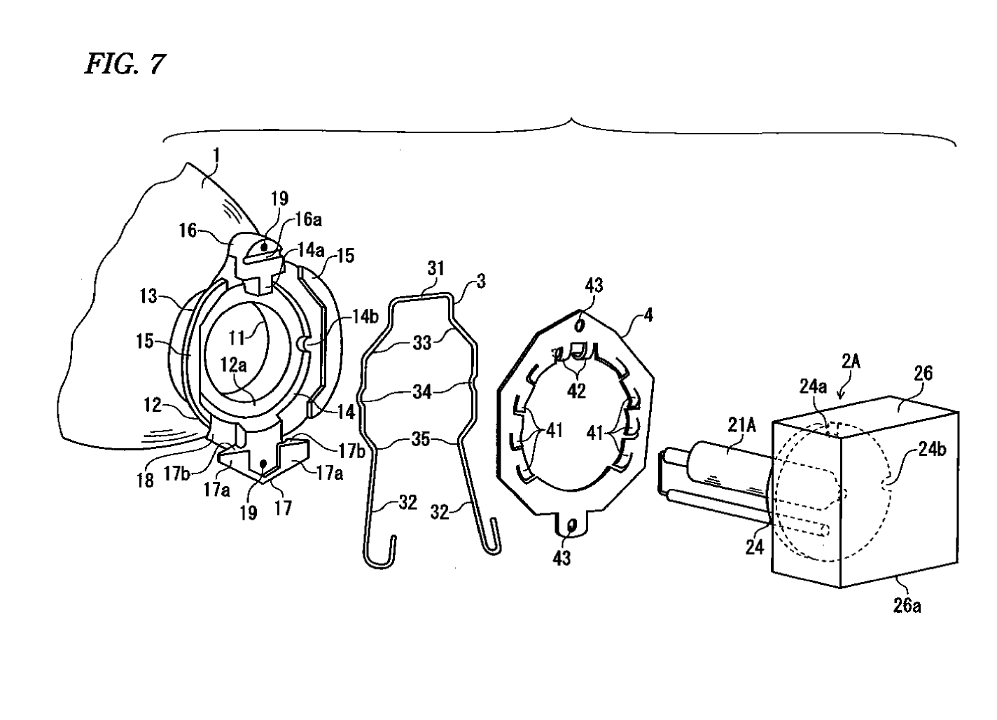

FIG. 7 is a partially exploded perspective view illustrating a second embodiment. Each component equivalent to those of the first embodiment is designated with the same reference numerals. In the second embodiment, a light source 2A is a discharge bulb equipped with a lighting circuit portion, i.e. an igniter. That is, the light source 2A includes a discharge bulb 21A, the disc flange 24 configured to support the discharge bulb 21A and fix the discharge bulb 21A to the reflector 1, and a lighting circuit portion 26 provided integrally on a back surface of the disc flange 24. The lighting circuit portion 26 has a metal casing 26a, and a lighting circuit is arranged inside the casing 26a. The lighting circuit portion 26 is electrically connected to an external power supply by a connector provided in a part of the casing. The configuration of the disc flange 24 is substantially the same as that of the disc flange of the bulb socket according to the first embodiment. An annular gap is provided between the disc flange 24 and the front surface of the casing 26a of the lighting circuit portion 26 so that the set spring 3 is inserted in the gap and abuts against the back surface of the disc flange 24.

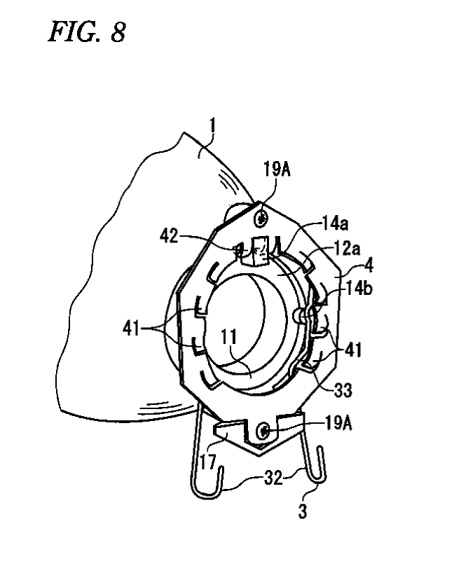

The configuration of the bulb mounting base 12 provided on the back surface of the reflector 1 according to the second embodiment is similar to that of the bulb mounting base according to the first embodiment. However, according to the second embodiment, a holder 4 is attached to the top surface of the outer wall 15 to be substantially closely attached to the top surface of the outer wall 15. The holder 4 is configured by an electrically conductive plate material, e.g., a metal plate in this case, which has an outer shape that is substantially octagonal, and an inner shape that is circular, so as to correspond to the wall portion 13 of the bulb mounting base 12. Screw holes 43 are opened in an upper portion and a lower portion in the circumferential direction of the holder 4, respectively. The holder 4 is fixed to the back surface of the wall portion 13 of the bulb mounting base 12 with screws 19A (see FIG. 8) through the screw holes 43, and two screw holes 19 provided in the back surface of the outer wall 15 of the bulb mounting base 12 to be closely attached thereto. The inner surfaces of the screw holes 19 are subjected to electric conduction processing so as to be electrically conducted to an electric conductive film provided on the back surface of the reflector 1. Electric conductive screws are used as the screws 19A. The holder 4 is such that the inside diameter thereof is larger than that of the disc flange 24 and substantially equal to the inside diameter of the outer wall 15. The holder 4 has a plurality of electrically-conducting tongues 41 along the inner circumference of the holder 4. The electrically-conducting tongues 41 are provided by forming cuts in the inner circumferential portion of the holder 4 and bending the cut portions in the thickness direction of the holder 4. Each of the electrically-conducting tongues 41 protrudes from the back surface of the holder 4 and is configured to electrically contact the front surface of the metal casing 26a of the lighting circuit portion 26 of the light source 2A as described below and to be electrically conducted thereto. The holder 4 also has two pressing tongues 42 at an upper portion of the holder 4. The pressing tongues 42 are spaced from each other in the circumferential direction of the holder 4, and are provided by cutting the holder 4 and bending the cut portions to protrude in the radially inward direction. The pressing tongues 42 are configured to be arranged at positions, at each of which a rectangular positioning protrusion 14a provided in the upper portion in the circumferential direction of the inner wall 14 is sandwiched in the circumferential direction by the tongue-like pieces 42, and to protrude therefrom in the direction of the inside diameter. As will be described, the pressing tongues 42 are configured to elastically contact the upper edge in the circumferential direction of the disc flange 24 of the light source 2A, and to urge the disc flange 24 downwardly in the circumferential direction.

The second embodiment is similar to the first embodiment in that the light source 2A is fixed to the reflector 1 using the set spring 3. As illustrated in FIG. 8, the set spring 3 is provided on the bulb mounting base 12. Then, the set spring 3 is covered with the holder 4 from above to thereby cause the bulb mounting base 12 to support the support portion 31. To perform such supporting thereof, a narrow concave groove 16a is formed in an upper portion in the circumferential direction of the outer wall 15 of the bulb mounting base 12. The support portion 31 of the set spring 3 is sealed in the concave groove 16a with the holder 4 attached to the bulb mounting base 12 by internally inserting the support portion 31 of the set spring 3 into the concave groove 16a. Thus, the set spring 3 is supported. The elastically-contacting portions 33 and the lock operating portions 32 of the set spring 3 are extended and arranged in a gap generated due to the difference in height between the outer wall 15 and the inner wall 14 of the wall portion 13. The lock operating portions 32 are arranged therein to protrude from the holder 4 and the wall portion 13 in the direction of the diameter thereof.

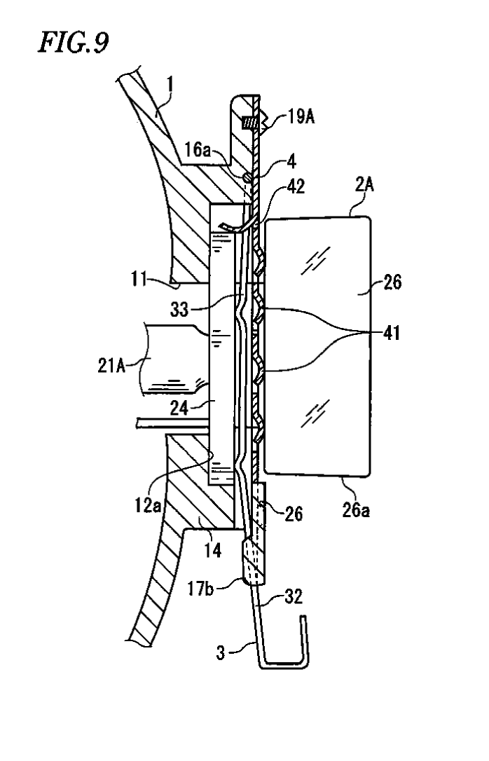

With the above configuration, an operation for fixing the light source 2A to the reflector 1 is similar to that in to the first embodiment. That is, the discharge bulb 21A of the light source 2A is inserted into the bulb inserting hole 11 from the side of the back surface of the reflector 1. The disc flange 24 is inserted to contact the bulb mounting base 12 surrounded by the inner wall 14. The front surface of the disc flange 24 is made to abut against the mounting surface 12a of the bulb mounting base 12. As illustrated in FIG. 9, the front surface of the casing 26a of the lighting circuit portion 26 elastically contacts the electrically-conducting tongues 41 that protrude from a rear surface of the holder 4. The casing 26a is electrically conducted to the reflector 1 via the electrically-conducting tongues 41. Thus, the casing 26a is brought into a grounded state. Simultaneously, the outer circumferential face of the disc flange 24 at the upper portion of the disc flange 24 elastically contacts the pressing tongues 42 of the holder 4 and is urged downwardly. The disc flange 24 is pressed with an urging force against the inner face of the inner wall 14 at the lower portion of the inner wall 14. Thus, the fixing position of the disc flange 24 on the bulb mounting base 12, i.e., the fixing position of the light source 2A is stabilized.

Then, similarly to the first embodiment, if the worker deforms the lock operating portions 32 of the set spring 3 by pinching and inwardly turning the lock operating portions 32, each of the lock operating portions 32 is inserted into the guide grooves 18. Simultaneously, the elastically contacting portions 33 are moved in the radially inward direction and inserted between the lighting circuit portion 26 and the disc flange 24. Thus, the elastically contacting portions 33 are moved to the back surface of the disc flange 24. The elastically contacting portions 33 are made to abut against the back surface of the disc flange 24 at the bent portions 34, 35. The abutment of the elastically contacting portions 33 thereon causes the elastically contacting portions 33 to be elastically deformed. A reaction force due to the elastic deformation causes the disc flange 24 to elastically contact the mounting surface 12a of the bulb mounting base 12. The elastic deformation of the set spring 3 urges the lock operating portions 32 towards the upper surface in the guide grooves 18. Consequently, when each of the lock operating portions 32 is moved beyond the associated latch protrusion 17a to the innermost end of the guide groove 18, each lock operating portion 32 is prevented from moving back across the associated latch protrusion and dropping off the associated guide groove 18 even when the worker releases his hand from the lock operating portions 32. The lock operating portions 32 are locked by the latch protrusions 17b. Accordingly, a state is maintained, in which each of the elastically contacting portions 33 elastically contacts the back surface of the disc flange 24 so as to elastically contact the mounting surface 12a. The light source 2A can be fixed to the bulb mounting base 12. That is, the set spring 3 elastically contacts the bulb mounting base 12 only by performing a single operation of inwardly deforming the left and right lock operating portions 32. Thus, the light source 2A can be fixed to the reflector 1. An operation of fixing the light source 2A can be simplified.

An operation to be performed in the case of removing the light source 2A from the reflector according to the second embodiment is similar to that according to the first embodiment. That is, the lock operating portions 32 are deformed by depressing each of the lock operating portions 32 in the direction of the lower surface of the associated guide groove 18. This depressing-deformation cancels the latching of the lock operating portions 32 by the latch protrusions 176. In addition, due to the elastic restoring force of the set spring 3, each of the lock operating portions 32 is moved beyond the associated latch protrusion 17b in the direction of the outside and goes off the associated guide groove 18. Simultaneously, each of the elastically contacting portions 33 is returned elastically and outwardly. Thus, each of the elastically contacting portions 33 retreats from the back surface of the disc flange 24. Consequently, a force for causing the disc flange 24 to elastically contact with the mounting surface 12a of the bulb mounting base 12 is released. Thus, the light source 2A can be removed from the reflector 1. Accordingly, the elastic contact state of the set spring 3 can be canceled only by performing a single operation of performing the depressing-deformation in one direction of each of the left and right lock operating portions 32 to the lower surface of the associated guide groove. The light source 2A can be removed from the reflector. An operation of removing a light source 2A can be simplified.

According to the second embodiment, with the holder 4 being attached to the bulb mounting base 12, when the light source 2A is fixed to the reflector 1, the casing 26a of the lighting circuit portion 26 is automatically electrically conducted to the reflector 1 via the electrically-conducting tongues 41 of the holder 4. The casing 26a can be put into a grounded state. Simultaneously, the light source 2A is pressed and held in a state, in which the light source 2A is urged to the lower side of the bulb inserting hole 11 of the reflector 1, by the pressing tongues 42 of the holder 4. Accordingly, it is unnecessary that an electric connection means for grounding the light source 2A be provided separately. Likewise, an independent means for restraining the position of the light source 2A is unnecessary. This is advantageous in simplifying the fixed structure.

In the second embodiment, an example of a discharge bulb integrally provided with an igniter as a lighting circuit portion has been described. However, the subject matter of the present disclosure also can be applied to a discharge bulb integrally equipped with a discharge lighting circuit portion including a circuit for generating a discharging high voltage.

While examples of fixing a light source to a reflector have been described above, the subject matter of the present disclosure is not limited thereto, and may also be applied to structures for fixing various light sources to a lamp body such as a lamp housing. Accordingly, other implementations are within the scope of the claim(s).

What is claimed is:

1. A light source fixing structure of a lamp, the structure comprising:
a lamp body comprising a mounting base on a back surface thereof;
a light source comprising a disc flange arranged to abut the mounting base; and
a set spring supported on the lamp body and elastically contacting the disc flange to fix the disc flange to the mounting base,
wherein the lamp body comprises a latch protrusion configured to lock the set spring,
wherein the set spring comprises:
a support portion supported on the lamp body;
a lock operating portion manually operable to engage the lock operating portion with the latch protrusion; and
an elastically contacting portion configured to elastically contact a back surface of the disc flange in a region between the support portion and the lock operating portion,
wherein the light source fixing structure is configured such that, an operation of the lock operating portion in one direction causes the elastically contacting portion to elastically contact the back surface of the disc flange and generates an elastic reaction force in a direction different from said one direction, and such that the elastic reaction force urges the lock operating portion toward the latch protrusion and causes the lock operating portion to engage with the latch protrusion.

2. The structure according to claim 1, wherein the set spring is a bent wire spring, the support portion being a central portion of the set spring, and the lock operating portion being a pair of end portions of the set spring elastically deformable in a direction in which the end portions move toward each other,
wherein the mounting base comprises a wall portion extending toward a back of the lamp body, the wall portion having a guide groove into which the lock operating portion is inserted when the end portions of the set spring are deformed in the direction in which the end portions move toward to each other,
wherein the guide groove is defined by an upper surface and a lower surface, and the latch protrusion is arranged on the upper surface to protrude toward the lower surface,
wherein the lock operating portion does not engage with the latch protrusion when the elastically contacting portion is not in contact with the back surface of the disc flange, and the lock operating portion engages with the latch protrusion when the elastically contacting portion contacts the back surface of the disc flange.

3. The structure according to claim 1, further comprising a holder attached to the lamp body and arranged to hold the support portion of the set spring between the holder and the lamp body,
wherein the light source further comprises a discharge bulb and a lighting circuit portion provided on the back surface of the disc flange, the lighting circuit portion comprising a casing,
wherein the holder is made of an electrically conductive plate, the holder comprising an electrically-conducting protrusion elastically contacting a front surface of the casing to electrically connect the casing to the lamp body, and a pressing protrusion elastically contacting a circumferential surface of the disc flange to urge the disc flange toward the mounting base.
